(19) United States
(12) Patent Application Publication
(10) Pub. No.: US 2003/0131506 A1
(43) Pub. Date: Jul. 17, 2003

(54) Self-personalized Candle

(76) Inventor: Matthew G. Frazer, Columbus, WI (US)

Correspondence Address: Matthew G. Frazer, 2652 Murphy Road, Portage, WI, 53901, US

(21) Appl. No.: 10/045,525

(22) Filed: Jan. 15, 2002

(51) Int. Cl. G09F 1/00

(52) U.S. Cl. 40/124.04; 40/725

(57) ABSTRACT

The unique candle cover will allow for an individual to create a personalized candle with his/her home computer and printer. The candle cover can be used for many applications such as but not limited to Memorial Candles, Baby Candles, Friendship Candles and Anniversary Candles. The candle software program will make the process of personalizing the insert card very straightforward. Then the personalized card can be slipped behind the candle covering to give it a “picture frame” effect. Creating a lasting keepsake for many years to come.

### BACKGROUND

The candle cover allows for a person to slide their personalized cards between the covering and the glass candle to give it a “picture frame” effect. With the aid of our Candle Printing Software Program it makes it easy for the individual to personalize his/her cards that slip behind the covering. The candle will be used for many applications such as but not limited to Memorial Candles, Baby Candles, Birthday Candles, Friendship Candles and Anniversary Candles. The backside of the covering allows for a second card to be slipped in. This card can be personalized with a prayer, poem, song or special message.

The candle will be sold as a “kit” where the individual can use their home computer and printer to personalize the cards and assemble the covering around the candle. Giving each candle a unique finish and offering a lasting keepsake for many years to come.

### SUMMARY

A unique candle cover that allows for personalized cards to be slipped behind the covering and give the cards a “picture frame” effect.

### DESCRIPTION OF DRAWINGS

FIG. 1a is a front view of the candle covering.

FIG. 2a is a back view of the candle covering.

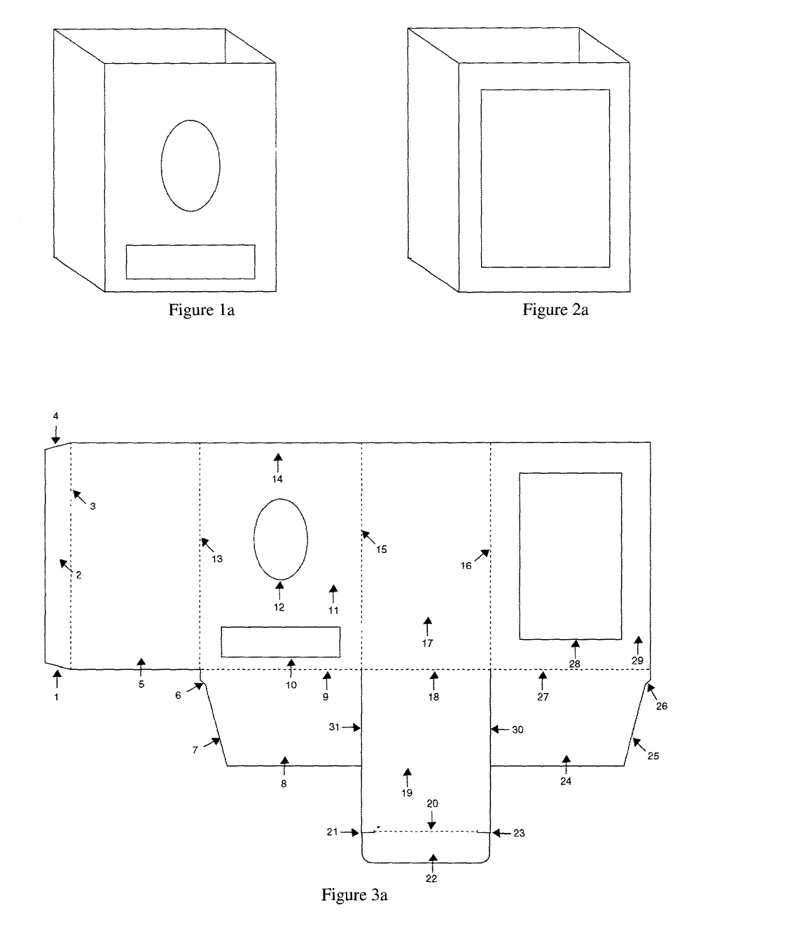

FIG. 1a is where the personalized card with the photo, names and dates will slip in.

FIG. 2a is where the personalized card with the poem, prayer or song will slip in.

### DETAILED DESCRIPTION OF INVENTION AND HOW IT WORKS

The covering will be explained from left to right as shown in FIG. 3a. The first tab 1,4 is the tab that has a strip of tape 2 that can be peeled off to adhere the tab so that the cover can make it's box like shape. Each area where the individual must fold the covering there are scored areas 3, 13, 15, 9, 18, 16, 27, 20 to make the process easy. The next panel 5 is the right side of the candle covering. There is also another piece of tape 14 that spans all the way across the entire upper area of the covering. This piece of tape is used to keep the cards and the covering in place. The cut out oval 12 window is where the photo will show through. Also on that same panel 11 the cut out rectangle 10 is supplied so that the names and dates can show through. The panel just below 8 is identical to 24 the panel that is directly across from it. The three bottom panels 8, 19, 24 are all designed to work together as one. The angle cuts 6, 26, 7, 25 allow for the tab 22 to lock in place. The cuts made just above the tab 21, 23 also play a key role in keeping the three flaps locked together. Two cuts are made 31, 30 so that the long 19 locking flap can overlay the other two 8, 24 to lock in to position. The left side 17 of the candle covering is the third panel. The backside of the candle covering 29 has the window 28 cut out so that an individual can slip the personalized card with a poem, prayer or song in behind.

Computer Program:

The candle printing software program makes it easy for the individual to personalize his/her card that slips behind the covering. The software program has a special guide that allows the individual to line up the photo and print it in the right position on the card so that when the card is slipped behind the covering in will be in the right position every time.

1. Unique cover with three cut outs that allow for the photo, names and dates and a special message to show through.

2. The covering has an oval cut out for a photo to show through.

3. The covering has a rectangle cut out for the names and dates to show through.

4. The covering has a rectangle window cut out so that a poem, prayer or song can show through.

5. The covering allows for the ability to slide a personalized card behind giving it a “picture frame” effect.

6. The covering can be assembled using the two tape strips that are provided.

7. The covering is made of an eighty-pound paper.

8. The covering is made of paper.

9. The covering has three bottom flaps, two that are identical and another, known as the locking flap, locks all three flaps into position.

10. The covering has scores to make folding and assembling easy.
